(19) United States
(12) Patent Application Publication
(10) Pub. No.: US 2005/0209753 A1
(43) Pub. Date: Sep. 22, 2005

(54) Passenger protection device

(75) Inventors: Armin Koehler, Sachsenheim (DE); Michael Roelleke, Leonberg-Hoefingen (DE)

Correspondence Address: KENYON & KENYON, ONE BROADWAY, NEW YORK, NY, 10004, US

(73) Assignee: Robert Bosch GmbH, Stuttgart (DE)

(21) Appl. No.: 10/514,012

(22) PCT Filed: Feb. 17, 2003
(86) PCT No.: PCT/DE03/00467

§ 371 Date: Nov. 8, 2004

(30) Foreign Application Priority Data
Jul. 6, 2002 (DE) 102 30 485.8

(51) Int. Cl. B60R 21/01

(52) U.S. Cl. 701/45; 280/735

(57) ABSTRACT

A device for vehicle occupant protection. A processor connectable to at least two sensors may execute a deployment algorithm, and, in response to a failure of at least one of the sensors, may alter a sequence of execution of the deployment algorithm according to a point in time of the failure.

### FIELD OF THE INVENTION

The present invention is directed to a device for vehicle occupant protection.

### BACKGROUND INFORMATION

A device for vehicle occupant protection may include sensors. For example, restraint systems having distributed sensors for frontal crash detection are recently being used in greater numbers. In order to obtain more information about the crash severity very early, sensors are installed in the actual crash zone. The side crash detection system needs such external sensors in the crash zone or in its proximity to actually be able to detect a side impact quickly enough. The trend in larger vehicles is to install more than one sensor per side. These sensors may fail. Failure of even one sensor may cause a total failure of the device.

An aspect of the present invention is to prevent a total failure of a device in the event of failure of an individual sensor or even a plurality of sensors.

### SUMMARY

In an example embodiment of the present invention, the failure of one sensor of a device for vehicle occupant protection may be taken into account in each phase of the deployment algorithm. This may prevent a total failure of the restraint system in the event of failure of an individual sensor or even a plurality of several sensors. A fallback strategy, adapted to each phase of the deployment algorithm, may be used for this purpose.

In one example embodiment, due to the greater complexity of current restraint systems, i.e., more sensors for the same task or function, in the event that one sensor fails, the overall functionality may remain intact with only negligible adverse effects on performance. Different approaches for the different phases of the algorithm may be used here.

In one example embodiment, in the event that one sensor fails when the device is switched on, either the device may be switched off again, or a corresponding flag may be set in a memory for influencing the threshold value computation for the deployment algorithm. It may be thereby established from the outset that this failure must be taken into account in the deployment algorithm.

In one example embodiment, in the event that one sensor fails during the threshold value computation, the signal of the failed sensor may be maintained via a constant. Alternatively, the sensitivity of the deployment algorithm may be altered, e.g., by lowering deployment thresholds.

In one example embodiment, in the event that at least one sensor fails prior to determining the plausibility, a processor may determine the plausibility in an alternative manner via an additional sensor.

Exemplary embodiments of the present invention are explained in greater detail in the following description.

### BRIEF DESCRIPTION OF THE DRAWINGS

FIG. 1 is a block diagram that illustrates the components of the device according to an example embodiment of the present invention.

FIG. 2 is a flow chart that illustrates a procedure according to an example embodiment of the present invention.

### DETAILED DESCRIPTION

In an embodiment of the present invention, a device for vehicle occupant protection may have a general response sequence in the event of sensor failures. The point in time of the sensor failure may be considered. The algorithm for computing the deployment of a restraint system may have different phases. A crash event may be anticipated in a first phase or the normal operation, also referred to as the reset state. The signals may be greater in a second phase of the threshold value computation than in normal driving situations, and the deployment algorithm may compute the deployment conditions from the signals. A comparison between the deployment conditions and the sensor signals may be executed in the deployment decision phase. In order to achieve greater reliability for the deployment of a restraint system, a plausibility check of the deployment condition may be executed in the plausibility phase using information from another sensor. An adapted strategy regarding the failure of at least one sensor may arise for each phase of this deployment algorithm. The device may be generally valid for restraint systems. The same demands may thus be made for many particular system configurations.

Compared to earlier systems, modern systems have greater complexity with regard to the plurality of sensors for the same task or function. This results in a certain redundancy. In an example embodiment, this redundancy may be utilized using a suitable failure strategy.

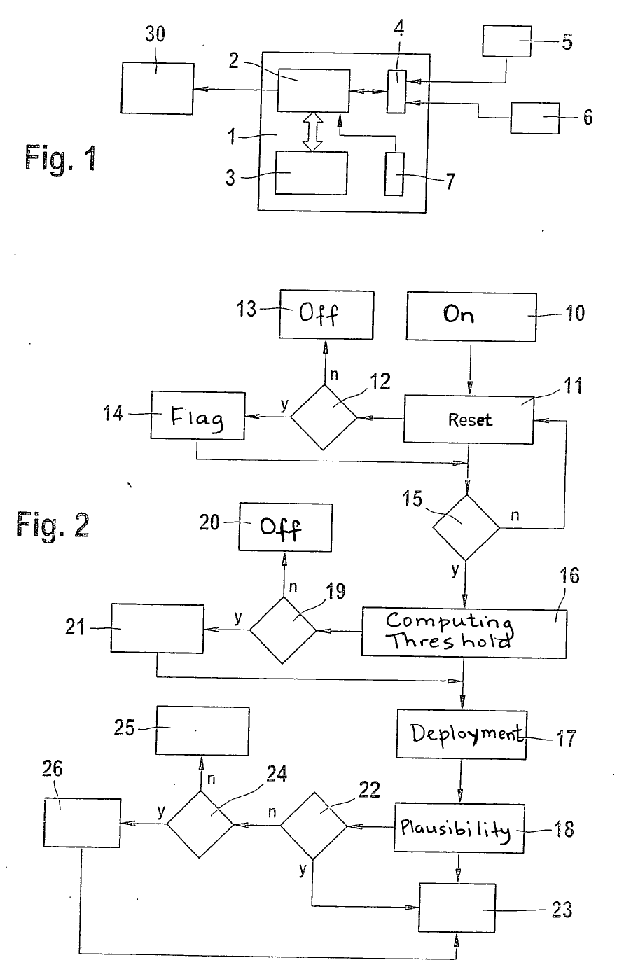

FIG. 1 shows a block diagram of the device according to an example embodiment of the present invention. The device may have a control unit 1 and external sensors 5 and 6. Such external sensor systems may be able to transmit pure sensor signals or pre-processed sensor signals, computed algorithm variables (thresholds, plausibilities), or deployment decisions.

These sensors 5 and 6 may be, for example, acceleration sensors, yaw rate sensors, temperature sensors, or pressure sensors. Other deformation sensors may be also possible. Sensors 5 and 6 may be connected to an interface module 4 that may be situated in control unit 1. In one example embodiment, unidirectional connections from sensors 5 and 6 to interface module 4 may be provided. In an alternative example embodiment, a bidirectional data transfer may be provided between interface module 4 and sensors 5 and 6. The unidirectional or bidirectional connections may be implemented by a bus connection between interface module 4 and sensors 5 and 6. Just one sensor, or three and more sensors may be connected to one interface module 4.

Interface module 4 may be designed as a receiver module that may receive the signals from sensors 5 and 6 and may transmit them to a processor 2 in control unit 1. Processor 2 may be configured as a microcontroller, as a microprocessor, or even as a hardware module having a specified logic. Processor 2 may analyze the sensor signals from sensors 5 and 6. In addition, another sensor 7 in control unit 1 may be connected to processor 2. This sensor 7 may be used as a plausibility sensor for sensing a side impact, for example. In one example embodiment, sensor 7 may be designed as an acceleration sensor or as a yaw rate sensor. In an example embodiment, more than one sensor may be provided in control unit 1, e.g., sensors having an angular sensitivity axis to one another. For ensuring its function, processor 2 may be connected to a memory 3 via a data input/output.

FIG. 2 is a flow chart that illustrates the procedure of the device according to an example embodiment of the present invention, e.g., which runs on processor 2. In an example embodiment, the device according to the present invention may be switched on in step 10. A normal operation, during which a crash event is anticipated, may be provided in subsequent step 11 referred to as RESET. If a failure of a sensor is determined in this phase of the deployment algorithm, e.g., the absence of the sensor signal, then the system may jump to step 12 in which it may be checked whether a fallback position exists. If this is not the case, then the system may jump to step 13 and the device according to the present invention may be switched off. If, however, a fallback condition is provided for the failure at this point in time, then a flag may be set in step 14, e.g., indicating the failure of a particular sensor. This may then be taken into account during computation of the deployment condition.

After step 14, the system may jump to step 15 which may be additionally reached by step 11 if there is no sensor failure. If starting conditions have been detected in step 15, for example by exceeding a noise threshold, the deployment algorithm may be started. The sensor signals may be taken into account here. If the noise threshold in step 15 was not exceeded, then the system may jump back to step 11. However, if the noise threshold was exceeded and the algorithm is started, then the system may move to step 16 in which the deployment conditions for the deployment of the restraining mechanism may be computed. If a sensor fails in this phase, the system may jump to step 19 in which it may be checked whether a fallback strategy exists for this phase. If this is not the case, then the device according to the present invention may be switched off in step 20. Otherwise, the system may jump to step 21 in which the fallback strategy for this phase of the deployment algorithm may be used. In one example embodiment, maintaining the signal of the failed sensor via a constant may constitute a fallback strategy. In an alternative embodiment, increasing the sensitivity of the deployment algorithm, e.g., by lowering the deployment thresholds, may constitute the fallback strategy. After applying the fallback strategy, the system may jump to step 17 in which the deployment decision may be made.

Subsequent to a deployment decision in step 17, the system may jump to step 18 for determining the plausibility of the deployment decision. If, however, a sensor failure was determined prior to computing the plausibility, e.g., failure of the sensor needed for the plausibility check, then the system may jump to step 22. In step 22 it may be checked whether a plausibility flag has already been set in memory 3 by processor 2. If this is the case, then the failure of the sensor is irrelevant and the system may jump to step 23 in which restraining mechanism 30 may be deployed. This deployment may take place adaptively. However, if it is determined in step 22 that the plausibility was not yet established, then the system may jump to step 24 in which it may be checked whether a fallback strategy exists for the plausibility phase. If this is not the case, then the device may be switched off in step 25. If, however, a fallback strategy does exist for the plausibility phase, then it may be used in step 26. The plausibility check may be executed here via a signal of another sensor, for example. This may be possible when there is sufficient redundancy of sensors. Subsequently, the system may jump to method 23 where restraining mechanism 30 may be deployed.

1-6. (canceled)

7. A device for vehicle occupant protection, comprising:
a processor to execute a deployment algorithm; and
at least two sensors to detect an impact, wherein the at least two sensors are connectable to the processor, and wherein, in response to a failure of at least one of the at least two sensors, the processor is to alter a sequence of execution of the deployment algorithm according to a point in time of the failure.

8. The device according to claim 7, wherein, if the at least one sensor fails when the device is switched on, the processor switches the device off.

9. The device according to claim 7, further comprising:
a memory, wherein, if the at least one sensor fails when the device is switched on, the processor sets a flag in the memory, and a threshold value of the deployment algorithm is computed according to the flag.

10. The device according to claim 7, wherein, if the at least one sensor fails during a threshold value computation of the deployment algorithm, the processor maintains a signal of the at least one sensor.

11. The device according to claim 7, wherein, if the at least one sensor fails during a threshold value computation of the deployment algorithm, the processor is to alter a sensitivity of the deployment algorithm.

12. The device according to claim 7, wherein, if the at least one sensor fails prior to a determination of a plausibility for a deployment condition, the processor determines the plausibility via another of the at least two sensors.
